(19) United States
(12) Patent Application Publication
(10) Pub. No.: US 2005/0094090 A1
(43) Pub. Date: May 5, 2005

(54) Spectacles and spectacles set

(76) Inventor: Takahiro Nishioka, Sabae-city (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/483,908

(22) PCT Filed: Jul. 16, 2002
(86) PCT No.: PCT/JP02/07223

(30) Foreign Application Priority Data
Jul. 16, 2001 (JP) 2001-215531
Oct. 12, 2001 (JP) 2001-315736

(51) Int. Cl. G02C 1/08

(52) U.S. Cl. 351/92

(57) ABSTRACT

Spectacles comprising a frame and lenses that are mounted in this frame, wherein the frame comprises an engagement holding mechanism near its middle when viewed from the front, for holding the lenses by engaging a mating component provided to the lenses; and an attraction holding mechanism near the two ends when viewed from the front, for holding the lenses by magnetic force. As a result, the lenses can be securely held and easily attached to and removed from the frame, without compromising the aesthetic design of the spectacles.

### TECHNICAL FIELD

This invention relates to spectacles and to a spectacles set, and more particularly relates to a spectacles and a spectacles set in which the lenses can be easily attached to and removed from the frame.

### BACKGROUND ART

Consumer preferences have shifted in recent years toward spectacles whose lenses can be detached from the frame, allowing the wearer to choose between a plurality of types of lenses according to the intended use, personal taste, or fashion coordination.

There has also recently been a move toward spectacles with more novel designs. For instance, there have been proposals for spectacles designed so that the frame will be as inconspicuous as possible, such as by making the frame thinner.

However, in cases where lenses are constructed so as to be detachable from the frame, a problem has arisen in that a mechanism must be provided on the lenses or frame to allow the attachment and detachment of the lenses, and this detachment mechanism stands out, adversely affecting the aesthetic design.

Furthermore, when the frame is made thinner or the left and right rims of the frame are constructed to support [only] the upper part of the lenses in order to make the frame stand out less, there is a danger that the lenses cannot be securely held by the frame.

In view of this, it is an object of the present invention to provide spectacles with which lenses that can be detached from the frame can be securely held by the frame, and in which, furthermore, the detachment mechanism will not adversely affect the aesthetic design.

### DISCLOSURE OF THE INVENTION

The spectacles pertaining to the present invention comprise a frame and lenses that are mounted in this frame, wherein the frame comprises an engagement holding mechanism near its middle when viewed from the front, for holding the lenses by engaging a mating component provided on the lenses; and an attraction holding mechanism near the two ends of the frame when viewed from the front, for holding the lenses by magnetic force.

Being constructed in this manner, the lenses can be detached from the frame and securely held by the frame without compromising the aesthetics of the spectacles. Also, the spectacles of the present invention allow the lenses to be easily installed and removed. Furthermore, the lenses or lens unit will not readily come out of the frame even if the temples are subjected to a force toward the left- and right-side directions of the frame when the spectacles are being put on or taken off.

The frame has a right rim, a left rim, a bridge that links the right and left rims, and temples linked to the right and left rims, the lenses consist of a right lens and a left lens, and the engagement holding mechanism comprises a first engagement holding mechanism that is provided on the right rim and engages and holds the end part of the right lens, and a second engagement holding mechanism that is provided on the left rim and engages and holds the end part of the left lens.

Being constructed in this manner, even if the temples are subjected to a force in the left and right directions of the frame when the spectacles are being put on or taken off, the first engagement holding mechanism and the second engagement holding mechanism will engage and hold the end parts of the lenses, and [the lenses] will also be held by attraction at the frame end parts so that the lenses will not readily come out of the frame.

The first and second engagement holding mechanisms each consist of at least one protruding part that is substantially U-shaped and whose open end extends facing the approximate center of the lens, and the end parts of the right and left lenses are engaged and held in the recessed parts demarcated by the insides of these substantially U-shaped curved portions.

Since the end parts of the lenses are engaged and held in the substantially U-shaped recessed parts of the protruding parts, the lenses will not readily come out of the frame even if the temples are subjected to a force in the left and right directions of the frame.

The protruding parts are preferably covered on at least the inside of the recessed parts with a silicone-based resin.

This prevents the lenses from being scratched. Also, since the resin provides an anti-slip function, covering with a resin allows the end parts of the lenses to be held in the recess portions more securely.

It is preferable that the first and second engagement holding mechanisms each comprise two protruding parts, and that the insides of the recessed parts covered with the silicone-based resin both form an arc with substantially the same radius of curvature.

As a result, even if the temples are subjected to a force in the left and right directions of the frame, the end parts of the lenses will be held at two points each near the middle of the frame, so the lenses will be even less likely to come out of the frame. Also, since the radius of curvature is substantially the same, the left and right lenses can be uniformly engaged and held by two protruding parts each, which even more effectively prevents the lenses from coming out.

The frame has a right rim, a left rim, a bridge that links the right and left rims, and temples linked to the right and left rims; the lenses consist of a right lens having a recessed part at its end and a left lens having a recessed part at its end; and the engagement holding mechanisms comprise the bridge, part of this bridge being engaged with the inside of the recessed parts in the right lens and part with the inside of the recessed parts in the left lens.

Being constructed in this manner, the lenses will not readily come out of the frame even if the temples are subjected to a force in the left and right directions of the frame when the spectacles are being put on or taken off.

The bridge comprises a first member which lies on substantially the same plane as the right and left rims, and which links the right and left rims; two post-shaped parts extending in post-shaped part toward the front; and a second member that links the front end parts of these two post-shaped part-shaped portions. The engagement holding mechanism is such that the two post-shaped parts are engaged and held in the recessed parts of the right lens and the recessed parts of the left lens respectively.

The post-shaped parts are in the form of cylinders that are threaded on their inside circumferences, and are integrated with the second member at the front end parts; the frame has two holes; and the bridge is constituted by inserting screws into the post-shaped parts through the holes from the back side when viewed from the front.

The post-shaped parts are in the form of cylinders that are threaded on their outside peripheries, and are integrated with the second member at the front end part; the frame has two holes; and the bridge is constituted by inserting the post-shaped parts into the holes and screwing nuts [onto the post-shaped parts] from the rear side when viewed from the front. Furthermore, washers may be interposed between the nuts and the frame.

It is preferable that the post-shaped parts be equipped with cylindrical silicone pipes around their outer peripheries. The elasticity of the silicone pipes protects the lenses, and also effectively prevents chatter in the engagement between the lens recessed parts and the post-shaped parts.

The bridge may also be constituted with washers interposed between the first members and the post-shaped parts. Interposing washers allows the lenses and the post-shaped parts to be properly engaged according to the thickness of the lenses.

The frame has a right rim, a left rim, a bridge that links the right and left rims, and temples linked to the right and left rims; the lenses consist of a lens unit in which the right and left lenses are linked via a linking part; and the engagement holding mechanisms comprise the bridge, the linking part being engaged by the bridge so as to hold the lens unit.

Being constructed in this way, even if the temples are subjected to a force in the left and right directions of the frame when the spectacles are being put on or taken off, the bridge will engage and hold the linking part of the lens unit, and [the lenses] will also be held by attraction at the frame end parts, so the lenses will not readily come out of the frame.

It is preferable that the right and left rims have a shape that complements the shape of the upper end part of the lenses. This makes the rims less noticeable and improves the aesthetic design.

It is preferable that the main component of the frame be beta-titanium or stainless steel. This gives the frame an appropriate amount of resiliency.

The attraction holding mechanism preferably comprises an attracting member provided on the lens, and an attracted member provided on the frame and attracted by the attracting member, and the end parts of the attracting members preferably protrude rearward from the lenses when viewed from the front. The attracting member and the attracted member may both be magnets, or one may be a magnet and the other a metal that is attracted to a magnet. This effectively prevents the lenses from falling out of their frame.

At least part of the attracted member may be fitted in a case, and this case may be fixed to the frame via a holding member (such as an arm) that absorbs force in the forward and rearward directions when viewed from the front.

The lenses may each have a hole into which the attracting member is inserted, the attracting member may be housed in a case that is threaded around its outer peripheral surface, and this case may be attached to the lens by being inserted into the hole.

A spectacles set pertaining to the present invention has the aforementioned frame, and a plurality of right lenses and a plurality of left lenses detachably attached to this frame.

Another spectacles set pertaining to the present invention has the aforementioned frame and a plurality of lens units detachably attached to said frame.

Also, the spectacles pertaining to the present invention comprise a frame and lenses that are mounted in said frame, wherein the frame comprises an engagement holding mechanism near its middle when viewed from the front, for holding the lenses by engaging a mating component provided to the lenses; and an attraction holding mechanism near the middle thereof when viewed from the front, for holding the lenses by magnetic force.

Because of this constitution, the lenses can be detached from the frame can be securely held by the frame, without compromising the aesthetics of the spectacles. Furthermore, the lenses will not readily come out of the frame even if the temples are subjected to a force in the left and right directions of the frame when the spectacles are being put on or taken off.

The lenses may consist of a right lens having a recess at the end, and a left lens having a recess at the end, and the engagement holding mechanism may comprise a protrusions that engage in the recesses of the right and left lenses.

The attraction holding mechanism may comprise an attracting member provided to the lens, and an attracted member provided to the frame and attracted by the attracting member.

The lenses may be rimless, or they may be equipped with rims made of metal or plastic. The attracting members may be embedded in the lenses, or the attracting member may be attached to the rim provided to the lenses.

### BRIEF DESCRIPTION OF THE DRAWINGS

FIG. 1 is an overall perspective view of the spectacles pertaining to Embodiment 1;

FIG. 2 is an overall perspective view of the frame pertaining to Embodiment 1;

FIG. 3 is a diagram of the portion A′ in FIG. 2, viewed in the direction of arrow II;

FIG. 4 is a perspective view pertaining to Embodiment 1, illustrating the state when the lenses are mounted in the frame;

FIG. 5 is a plan view of FIG. 4;

FIG. 6 is a diagram pertaining to Embodiment 1, illustrating the state when the lenses are stored in their storage case;

FIG. 7 is an overall perspective view of the spectacles pertaining to Embodiment 2;

FIG. 8 is a plan view of the spectacles shown in FIG. 7;

FIG. 9 is an overall perspective view of the frame pertaining to Embodiment 2;

FIG. 10 is a perspective view pertaining to Embodiment 2, illustrating the state when the lens unit is mounted in the frame;

FIG. 11 is a plan view of FIG. 10;

FIG. 12 is an overall perspective view of the spectacles pertaining to Embodiment 3;

FIG. 13 is a plan view of the spectacles shown in FIG. 12;

FIG. 14 is an overall perspective view of the frame pertaining to Embodiment 3;

FIG. 15 is a perspective view pertaining to Embodiment 3, illustrating the state when the lenses are mounted in the frame;

FIG. 16 is an overall perspective view of the spectacles pertaining to Embodiment 4;

FIG. 17 is an overall perspective view of the frame pertaining to Embodiment 4;

FIG. 18 is a perspective view pertaining to Embodiment 4, illustrating the state when the lenses are mounted in the frame;

FIG. 19 is a plan view of FIG. 16; 13;

FIG. 20 is a diagram illustrating the structure of the bridge;

FIG. 21 is a plan view of the spectacles pertaining to Embodiment 5;

FIG. 22 is a diagram illustrating another structure of the bridge;

FIG. 23 is an overall perspective view of the spectacles pertaining to Embodiment 9;

FIG. 24 is a perspective view pertaining to Embodiment 9, illustrating the state when the lens unit is mounted in the frame;

FIG. 25 is a plan view of FIG. 23;

FIG. 26 is a detail enlargement illustrating the attraction holding state produced by magnets;

FIG. 27 is a detail enlargement illustrating the attraction holding state produced by magnets in the spectacles pertaining to Embodiment 10;

FIG. 28 is a detail enlargement illustrating the attraction holding state produced by magnets in the spectacles pertaining to Embodiment 11;

FIG. 29 is a diagram of the state when a magnet case is inserted into a lens;

FIG. 30 is a diagram illustrating another structure of the bridge;

FIG. 31 is a diagram illustrating another structure of the bridge;

FIG. 32 is a diagram illustrating another structure of the bridge;

FIG. 33 is a detail enlargement of a plan view of the spectacles pertaining to Embodiment 8;

FIG. 34 is an overall oblique view of the spectacles pertaining to Embodiment 12;

FIG. 35 is a diagram illustrating how the lenses are mounted in the frame in Embodiment 12;

FIG. 36 is a diagram illustrating another structure of the lenses;

FIG. 37 is a diagram illustrating another structure of the lenses;

FIG. 38 illustrates the lenses pertaining to Embodiment 13; and

FIG. 39 is a diagram illustrating how the lenses are mounted in the frame in Embodiment 13.

### BEST MODE FOR CARRYING OUT THE INVENTION

Embodiments of the present invention will now be described through reference to the drawings.

First Embodiment

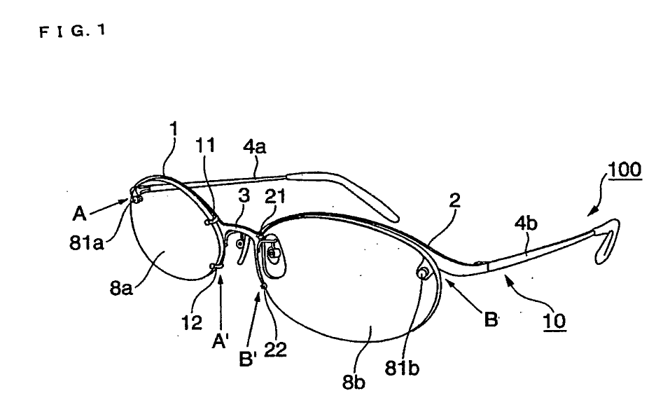

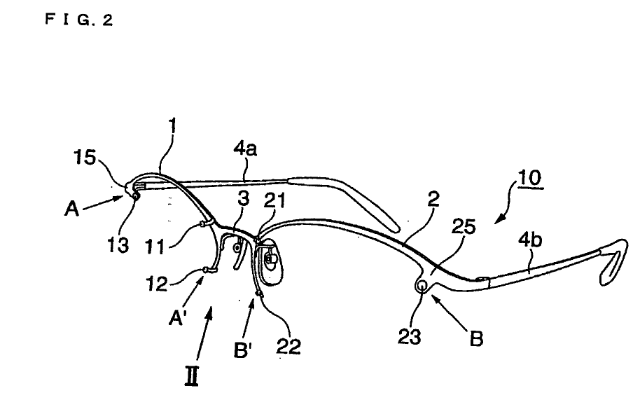

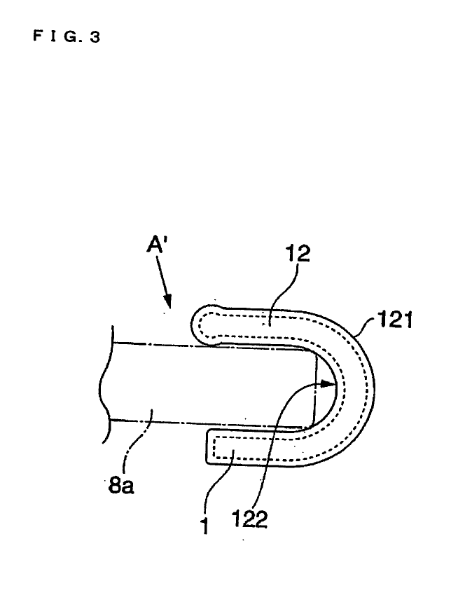

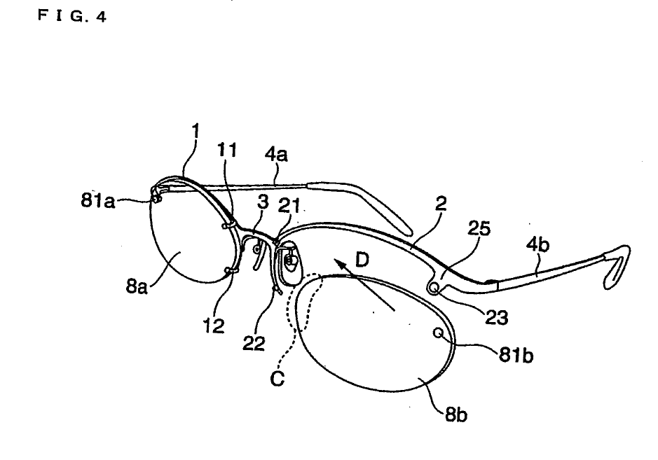

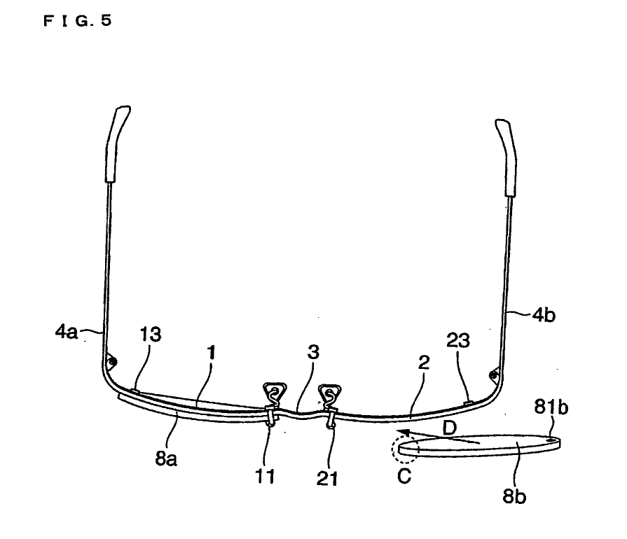

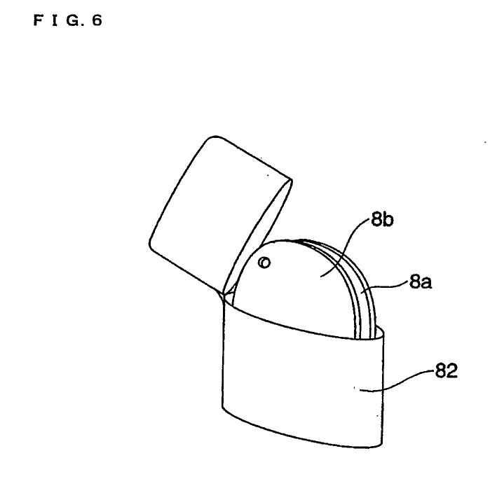

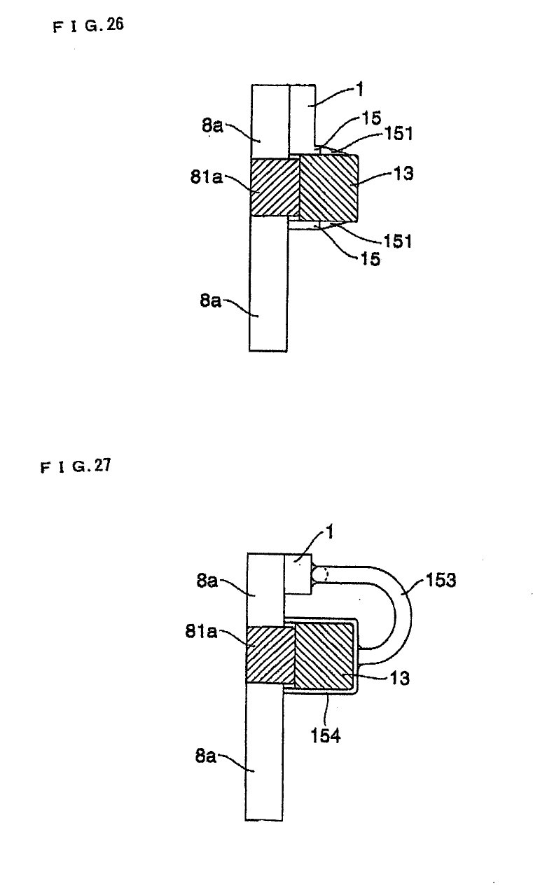

FIG. 1 is an overall perspective view of the spectacles pertaining to Embodiment 1, FIG. 2 is an overall perspective view of the frame, FIG. 3 is a diagram of the portion A′ in FIG. 2 when viewed in the direction of arrow II, FIG. 4 is a perspective view illustrating the state when the lenses are mounted in the frame, FIG. 5 is a plan view of FIG. 4, FIG. 6 is a diagram illustrating the state when the lenses are stored in their storage case, and FIG. 26 is a detail enlargement illustrating the attraction holding state produced by magnets.

As shown in FIG. 1, a pair of spectacles 100 comprises a frame 10 and lenses 8a and 8b. The frame 10 comprises a right rim 1, a left rim 2, a bridge 3 that links the right rim 1 and left rim 2, a temple 4a linked to the right rim 1, and a temple 4b linked to the left rim 2.

The right rim 1 and left rim 2 are substantially ring-shaped, with the lower portion of the ring missing, and have a shape that complements the shape of the upper ends of the lenses 8a and 8b. Specifically, the right rim 1 has a shape that complements the shape of the upper end of the lens 8a, from the portion A near the temple 4a to the portion A′ near the bridge 3. The left rim 2 has a shape that complements the shape of the upper end of the lens 8b, from the portion B near the temple 4b to the portion B′ near the bridge 3.

As shown in FIG. 2, the right rim 1 has a protruding part 11 near the bridge 3, and a protruding part 12 near the portion A′. The left rim 2 has a protruding part 21 near the bridge 3, and a protruding part 22 near the portion B′.

As shown in FIG. 3, the protruding part 12 is substantially U-shaped, and the open end of this U-shape extends toward the front in the approximate center of the lens. Specifically, the distal end of the protruding part 12 is curved toward the temple 4a in the direction in which the lens is housed. The surface of the protruding part 12 (in this embodiment, not just the inside of the recessed part, but the entire surface of the protruding part) is covered with a silicone-based resin 121. An arc shape in which the end part of the lens is engaged and held is demarcated by this coated recessed part inner side 122. The protruding parts 11, 21, and 22 are all structured the same as the protruding part 12, and the arc-shaped insides of the recessed parts that are covered with resin all have the same radius of curvature.

The right rim 1 has a flange 15 near the portion A which extends toward the bridge 3 in the direction in which the right lens 8a is housed. To this flange 15 is attached a small, cylindrical magnet 13 that is inserted into a hole in the flange 15. As shown in FIG. 26, the peripheral surface of the magnet 13 extending from the frame 10 is reinforced by an epoxy resin, an adhesive agent, or another such resin 151, this structure preventing the magnet 13 from falling out of the frame 10.

The left rim 2 has a flange 25 near the portion B which extends toward the bridge 3 in the direction in which the lens is housed. To this flange 25 is attached a small, cylindrical magnet 23 that is inserted into a hole in the flange 25. The magnet 23 is also attached to the flange 25 by the structure shown in FIG. 26.

The magnets 13 and 23 preferably have an average flux density of 400 to 8000 gauss. It is also preferable for the magnets 13 and 23 to be made from [an alloy of] neodymium/iron/boron. The magnets 13 and 23 are not limited to a cylindrical shape, but may instead be a hexagonal prism, quadrangular prism, and so on.

The lens 8a is attached to the right rim 1, and the lens 8b is attached to the left rim 2. Colored lenses with no diopter are used as the lenses 8a and 8b. A small, cylindrical magnet 81a is embedded near the portion A of the lens 8a, and a small, cylindrical magnet 81b is embedded near the portion B of the lens 8b. As shown in FIG. 26, the end part of the magnet 81a extends from the lens 8a toward the rear, as viewed from the front. In this way, the end part of the magnet 81a thus extends from the lens 8a, and the magnet 13 is provided on the flange 15 such that it retracts toward the rear when viewed from the front, the extended end part of the magnet 81a is housed in the recessed part formed by the flange 15 and the magnet 13, which effectively prevents the lens 8a from falling out of the frame. The lens 8b has a similar relationship with the magnet 23.

The method of attaching the lens 8b will now be described through reference to FIGS. 4 and 5.

The lens 8b is moved in the direction of arrow D, and the end part of the lens 8b (portion C) is engaged and held in the recessed parts of the protruding parts 21 and 22. At this time, the magnet 23 provided on the left rim 2, and the magnet 81b provided on the lens 8b exert a pull on each other by magnetic force. This allows the lens 8b to be attached to the left rim 2 with ease, without having to use a tool or the like. The lens 8a can be attached with similar ease to the right rim 1.

In Embodiment 1, the effect of the above structure is that the lenses 8a and 8b will not readily come out of the frame 10 even if the temples 4a and 4b are subjected to a force in the left and right directions of the frame 10 when the spectacles 100 are being put on or taken off, allowing the lenses 8a and 8b to be held securely. Specifically, when the temples 4a and 4b are subjected to a force in the left and right directions of the frame 10, a large force is exerted between the lenses 8a and 8b and the frame 10 near the middle of the frame 10, and this results in misalignment between the lenses 8a and 8b and the protruding parts 11, 12, 21, and 22, but because the lens end parts are engaged and held by the protruding parts 11, 12, 21, and 22 at four places near the middle of the frame, and are held by magnetic force near the two ends of the frame, the lenses are effectively prevented from coming out of the frame 10. In particular, because the radius of curvature of the arc of the coated insides of the recessed parts of the protruding parts 11 and 12 is substantially the same as the radius of curvature of the arc of the coated insides of the recessed parts of the protruding parts 21 and 22, the lens 8a is uniformly engaged and held by the protruding parts 11 and 12, and the lens 8b is uniformly engaged and held by the protruding parts 21 and 22, which prevents even more effectively the lenses 8a and 8b from coming out.

If a plurality of lenses of different color, diopter, etc., are readied as the lenses 8a and 8b, then the wearer can choose between the lenses according to the intended use, personal taste, or fashion coordination.

As shown in FIG. 6, the lenses 8a and 8b can be stored in a storage case 82. Keeping the lenses in the storage case 82 is convenient because it allows them to be carried in a pocket, bag, etc. When replacement lenses are provided, it is even more convenient to keep these in the storage case 82.

Another option is to use a lens unit in which the lenses 8a and 8b are linked via a linking part, with the lens 8a being engaged and held by the protruding parts 11 and 12, and the lens 8b being engaged and held by the protruding parts 21 and 22.

Second Embodiment

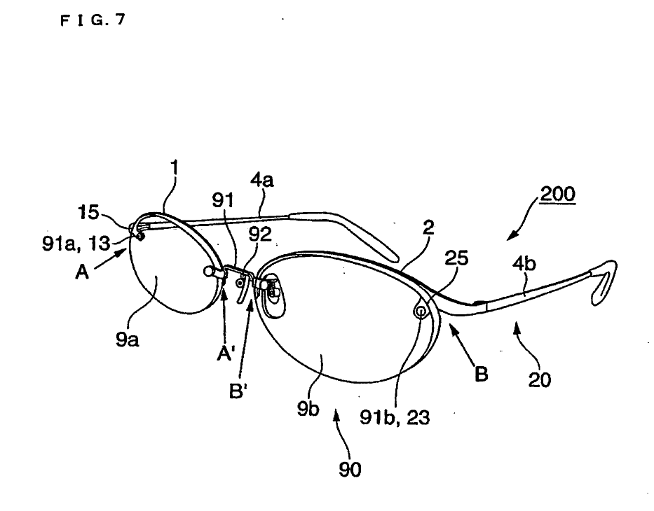

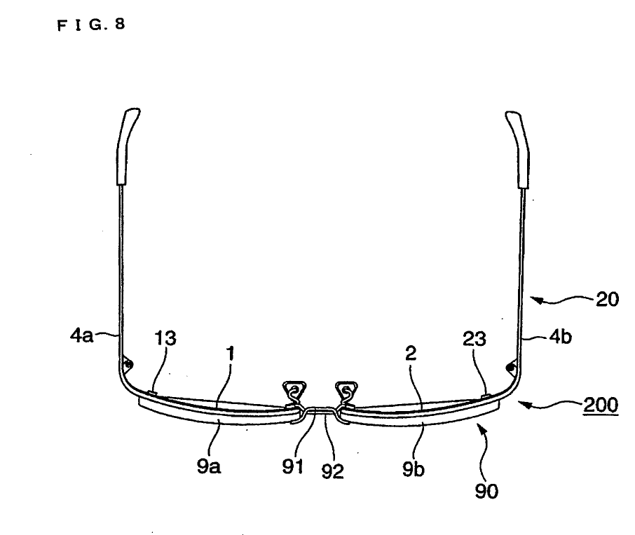

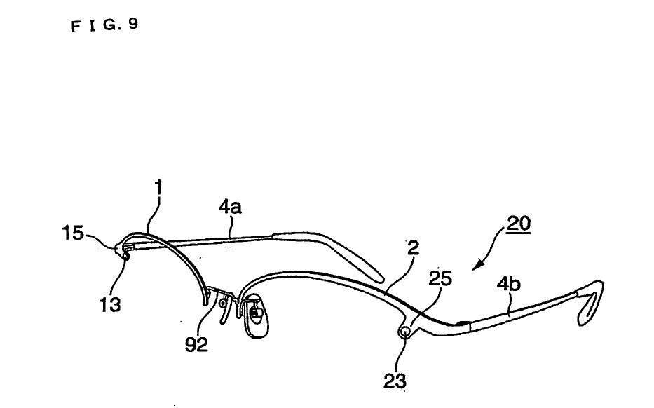

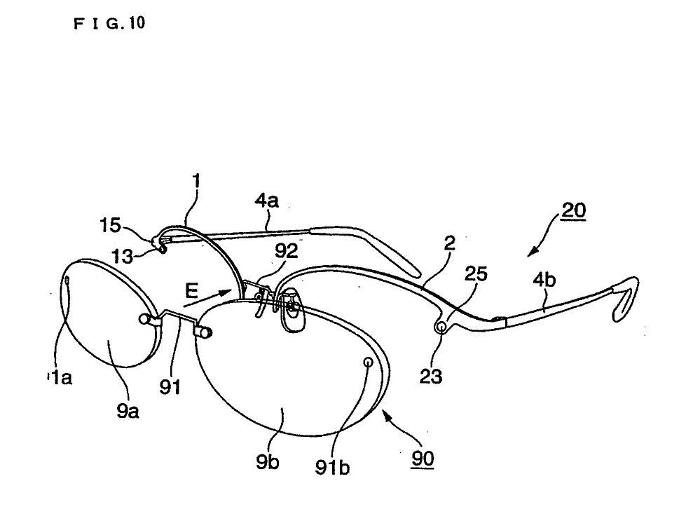

FIG. 7 is an overall perspective view of the spectacles pertaining to Embodiment 2; FIG. 8 is a plan view of the spectacles shown in FIG. 7, FIG. 9 is an overall perspective view of the frame pertaining to Embodiment 2, FIG. 10 is a perspective view illustrating the state when the lens unit is mounted in the frame, and FIG. 11 is a plan view of FIG. 10.

In Embodiment 2, those members that are the same as in Embodiment 1 are numbered the same, and will not be described in detail again.

As shown in FIGS. 7 through 11, the spectacles 200 pertaining to Embodiment 2 differ from those in Embodiment 1 in that a lens unit 90 is mounted on a frame 20. The frame 20 comprises the right rim 1, the left rim 2, a bridge 92 that links the right rim 1 and left rim 2, the temple 4a linked to the right rim 1, and the temple 4b linked to the left rim 2.

Similarly to Embodiment 1, the right rim 1 and left rim 2 have a ring shape in which the lower portion of the ring is missing, and have a shape that complements the shape of the upper end parts of lenses 9a and 9b. The bridge 92 is substantially a box section in shape, open at the bottom. Just as in Embodiment 1, the right rim 1 and left rim 2 have flanges 15 and 25 into which cylindrical magnets 13 and 23 are fitted, respectively.

As shown in FIGS. 10 and 11, the lens unit 90 comprises a lens 9a, a lens 9b, and a linking part 91 that links the lens 9a and lens 9b. Colored lenses with no diopter are used as the lenses 9a and 9b. A small, cylindrical magnet 91a is embedded at the portion of the lens 9a near the temple 4a, and a small, cylindrical magnet 91b is embedded at the portion of the lens 9b near the temple 4b. The linking part 91 is substantially a box section in shape, open at the bottom, and this substantially open-box shape complements the substantially open-box shape of the bridge 92, being slightly larger than the bridge 92.

Next, the method for attaching the lens unit 90 to the frame 20 will be described through reference to FIGS. 10 and 11.

The lens unit 90 is moved in the direction of arrow E, and the linking part 91 is engaged from above with the bridge 92 so that the substantially open-box shape of the bridge 92 is accommodated in the substantially open-box shape of the linking part 91. At this time, the magnet 13 provided on the right rim 1, and the magnet 91a provided on the lens unit 90 exert a pull on each other by magnetic force, as do the magnet 23 provided on the right rim 2 and the magnet 91b provided on the lens unit 90. This allows the lens unit 90 to be attached to the frame 20 with ease, without having to use a tool or the like.

In Embodiment 2, the effect of the above structure is that the lens unit 90 will not readily come out of the frame 20 even if the temples 4a and 4b are subjected to a force in the left and right directions of the frame 20 when the spectacles 200 are being put on or taken off, allowing the lens unit 90 to be held securely. Specifically, when the temples 4a and 4b are subjected to a force in the left and right directions of the frame 20, a large force is exerted between the lens unit 90 and the frame 20 near the middle part of the frame 20, but because the linking part 91 and the bridge 92 are engaged and held near the middle of the frame, and are held by magnetic force near the two end parts of the frame, the lens unit 90 is effectively prevented coming out of the frame 20.

If a plurality of lens units of different color, diopter, etc., from those of the above-mentioned lens unit 90 are readied, then the wearer can choose between the lens units according to the intended use, personal taste, or fashion coordination.

In the above embodiment, it is possible for just the magnets 13 and 23 on the frame side, or just the magnets 91a and 91b on the lens unit side to be magnets, and for the others to be made from a metal that is attracted to a magnet.

Third Embodiment

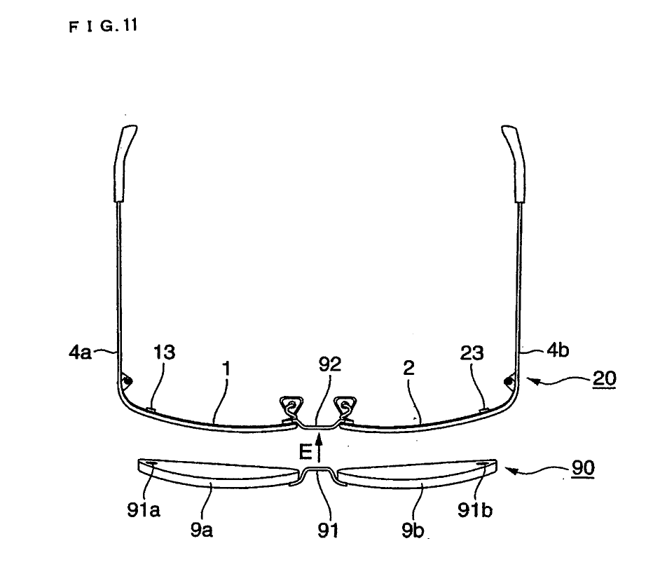

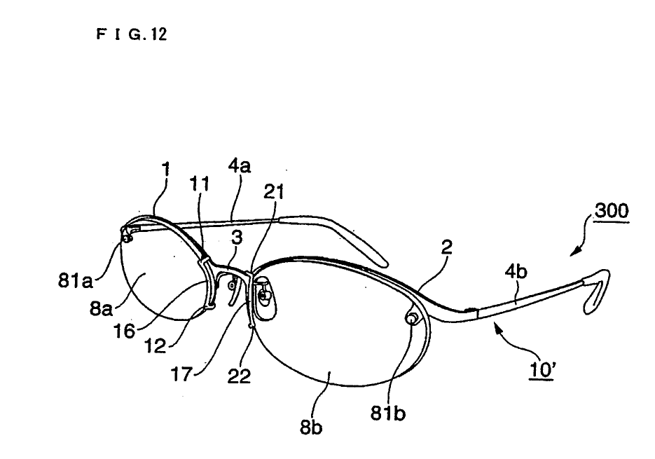

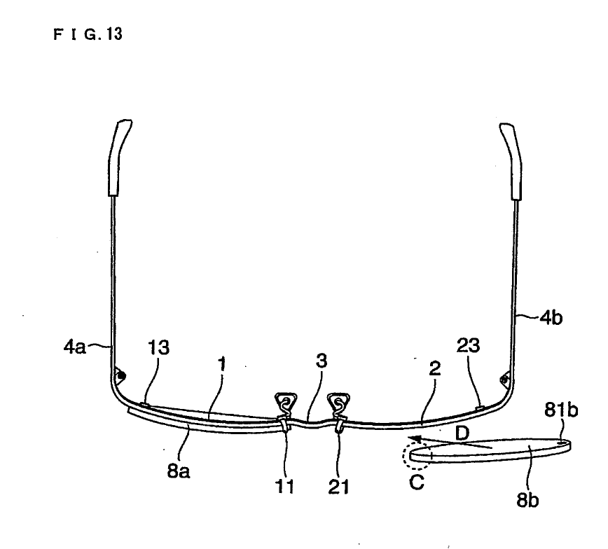

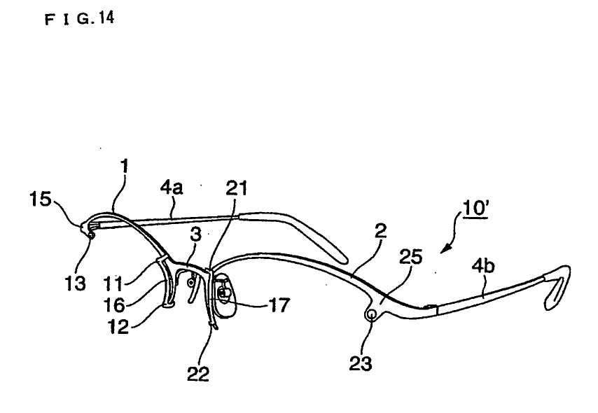

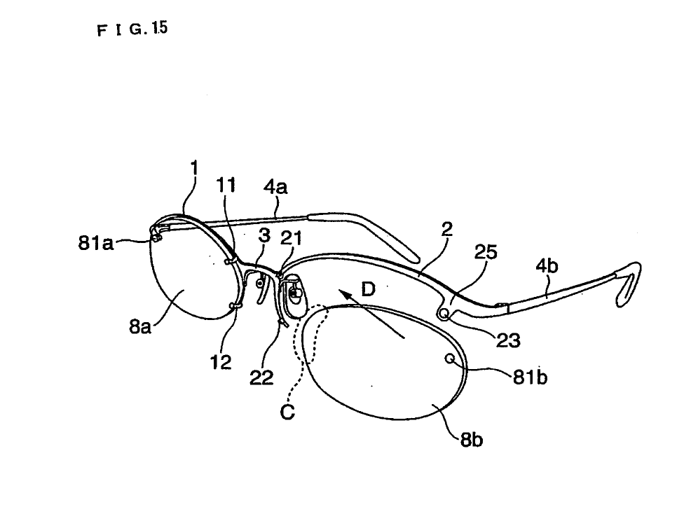

FIG. 12 is an overall perspective view of the spectacles pertaining to Embodiment 3, FIG. 13 is a plan view of the spectacles shown in FIG. 12, FIG. 14 is an overall perspective view of the frame, and FIG. 15 is a perspective view illustrating the state when the lenses are mounted in the frame.

In Embodiment 3, those members that are the same as in Embodiment 1 are numbered the same, and will not be described in detail again.

As shown in FIGS. 12 through 15, the spectacles 300 pertaining to Embodiment 3 differ from those in Embodiment 1 in that the protruding parts 11 and 12 are linked at their extended distal ends by a member 16, and the protruding parts 21 and 22 are linked at their extended distal ends by a member 17.

The lens 8b is moved in the direction of arrow D, and the end of the lens 8b (portion C) is engaged and held in the recessed parts of the protruding parts 21 and 22 to be attached to the left rim in the same fashion as in Embodiment 1. The lens 8a is similarly attached to the right rim 1 by engaging the holding the end of the lens 8a in the recessed parts of the protruding parts 11 and 12.

In Embodiment 3, the end part of the lens 8a is engaged and held by the protruding parts 11 and 12 and the member 16, and the end part of the lens 8b is engaged and held by the protruding parts 21 and 22 and the member 17, and [the end parts of the lenses 8a, 8b] are held by magnetic force near the two end parts of the frame, so the lenses 8a and 8b are effectively prevented from coming out of the frame 10′. Specifically, the members 16 and 17 help the protruding parts 11, 12, 21, and 22 to engage and hold the lenses, which allows the lenses to be held securely while still allowing the lenses to be installed and removed with ease.

In Embodiment 3 as in Embodiment 1, the lenses 8a and 8b may be kept in the storage case 82 shown in FIG. 6.

Fourth Embodiment

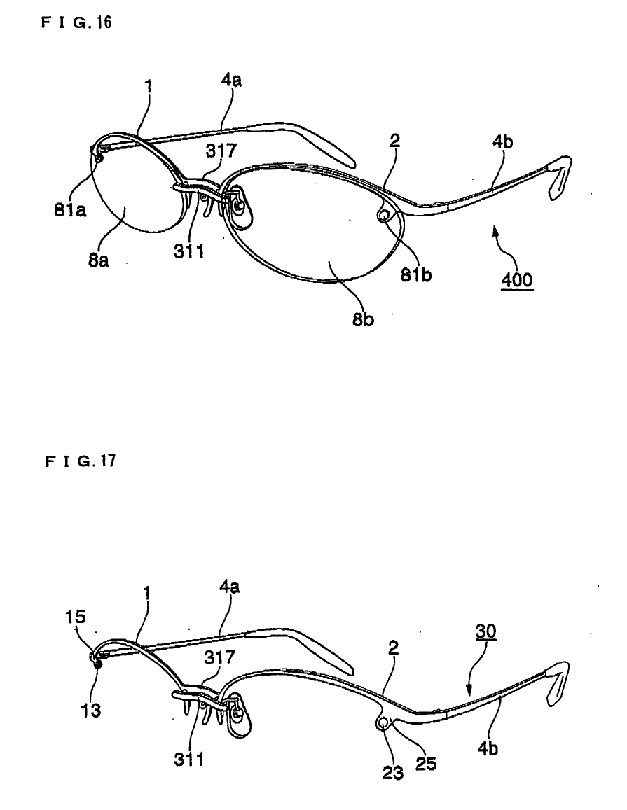

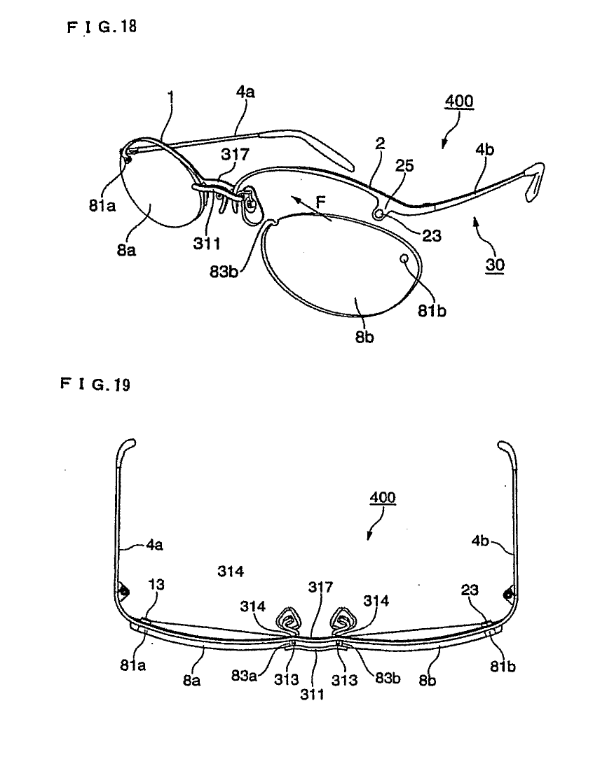

FIG. 16 is an overall perspective view of the spectacles pertaining to Embodiment 4, FIG. 17 is an overall perspective view of the frame, FIG. 18 is a perspective view illustrating the state when the lenses are mounted in the frame, FIG. 19 is a plan view of FIG. 16; and FIG. 20 is a diagram illustrating the structure of the bridge. Those members in Embodiment 4 that are the same as in Embodiment 1 are numbered the same, and will not be described in detail again.

As shown in FIGS. 16 through 20, the spectacles 400 pertaining to Embodiment 4 differ from those in Embodiment 1 in the structure of the bridge, and in that the lenses 8a and 8b have recessed parts 83a and 83b, respectively, at the end parts near the bridge.

The bridge comprises a first member 317 that lies on substantially the same plane as the right rim 1 and left rim 2 and links the right rim 1 and left rim 2, two post-shaped parts 312 extending in post shape from the first member 317 toward the front, a second member 311 that links the front ends of the two post-shaped parts 312, two cylindrical silicone pipes 313, and two screws 314.

As shown in FIG. 20, the post-shaped parts 312 are cylindrical and are threaded around the inside. The front ends of the post-shaped parts 312 are fixed to the second member 311. The frame 30 has two holes 315. The post-shaped parts 312 are put inside the silicone pipes 313, after which the screws 314 are inserted through the holes 315 from the rear (when viewed from the front) into the post-shaped parts 312, thereby constituting the bridge.

The lens 8b is moved in the direction of arrow F, and the post-shaped part 312 housed in the silicone pipe 313 is engaged in the recessed part 83b at the end part of the lens 8b to attach [the lens 8b] to the left rim 2. The lens 8a is similarly attached to the right rim 1 by engaging the post-shaped part 312 in the recessed part 83a of the lens 8a.

In Embodiment 4, parts of the bridge (the post-shaped parts 312 housed in the silicone pipes 313) are engaged in the recessed parts 83a and 83b of the lenses, and the lenses 8a and 8b are also held by magnetic force near the two ends of the frame, so the lenses 8a and 8b are effectively prevented from coming out of the frame 30. Also, because the post-shaped parts 312 are housed in the silicone pipes 313, the lenses 8a and 8b are protected by the elasticity of the silicone pipes 313, and this elasticity also effectively prevents chatter in the engagement between the post-shaped parts 312 and the recessed parts 83a and 83b of the lenses 8a and 8b.

Again in Embodiment 4, as in Embodiment 1, the lenses 8a and 8b may be kept in the storage case 82 shown in FIG. 6.

Fifth Embodiment

FIG. 21 is a plan view of the spectacles pertaining to Embodiment 5, and FIG. 22 is a diagram illustrating the structure of the bridge. As shown in FIGS. 21 and 22, the spectacles 400′ pertaining to Embodiment 5 differ from those in Embodiment 4 in that washers 316 are further provided to the bridge.

As shown in FIGS. 21 and 22, the bridge is constituted with washers interposed between the first members 317 and the post-shaped parts 312. When the washers 316 are suitably interposed in this manner, the lenses 8a and 8b and the post-shaped parts 312 can be properly engaged according to the thickness of the lenses 8a and 8b.

Sixth Embodiment

FIG. 30 is a diagram illustrating the structure of the bridge in the spectacles pertaining to the sixth embodiment. The spectacles pertaining to the sixth embodiment differ from those in Embodiment 4 only in the structure of the bridge.

As shown in FIG. 30, post-shaped parts 318 are threaded around the outer periphery, and the front ends of the post-shaped parts 318 are fixed by brazing to the second member 311. The post-shaped parts 318 are put inside the silicone pipes 313, after which the distal ends of the post-shaped parts 318 are inserted through the holes 315, and nuts 320 are screwed onto these distal ends from the rear (when viewed from the front), with washers 319 interposed, thereby constituting the bridge.

Again in Embodiment 6, as in Embodiment 4, chatter can be effectively prevented in the engagement between the post-shaped parts 318 and the recessed parts 83a and 83b of the lenses 8a and 8b.

Seventh Embodiment

FIG. 31 is a diagram illustrating the structure of the bridge in the spectacles pertaining to Embodiment 7. As shown in FIG. 31, the spectacles pertaining to Embodiment 7 differ from those in Embodiment 6 in that washers 321 are further provided on the bridge.

As shown in FIG. 31, the bridge is constituted with the washers 321 interposed between the first members 317 and the post-shaped parts 318. When the washers 321 are suitably interposed in this manner, the lenses 8a and 8b and the post-shaped parts 318 can engaged according to the thickness of the lenses 8a and 8b.

Eighth Embodiment

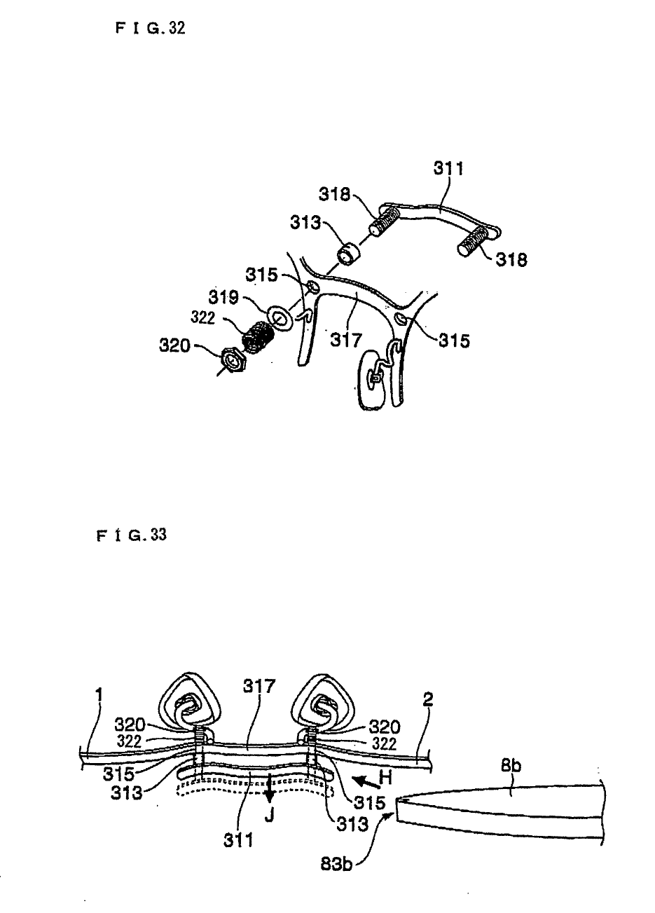

FIG. 32 is a diagram illustrating the structure of the bridge in the spectacles pertaining to Embodiment 8, and FIG. 33 is a detail enlargement of a plan view of the spectacles. As shown in FIGS. 32 and 33, the spectacles pertaining to Embodiment 8 differ from those in Embodiment 6 in that springs 321 are further provided to the bridge.

As shown in FIGS. 32 and 33, the bridge is constituted with springs 321 interposed between the washers 319 and the nuts 320.

In a state in which the second member 311 has been moved in the direction of arrow J, the lens 8b is moved in the direction of arrow H, causing part of the bridge (the post-shaped part 318 housed in the silicone pipe 313) to engage in the recessed part 83b of the lens, thereby attaching [the lens] to the left rim 2. The lens 8a is similarly attached.

In Embodiment 8, the effect of interposing the springs 321 is that the second member 311 is pulled toward the front, and the lenses 8a and 8b are attached by being sandwiched between the second member 311 and the frame (the first member-317 and the left and right rims 1 and 2) by the elastic force of the springs 321, so the lenses and the post-shaped parts 318 can be properly engaged according to the thickness of the lenses 8a and 8b.

Ninth Embodiment

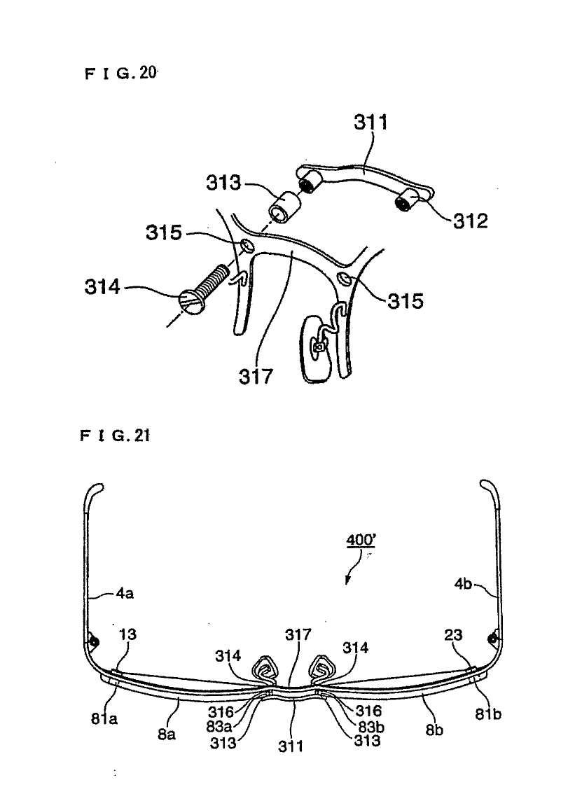

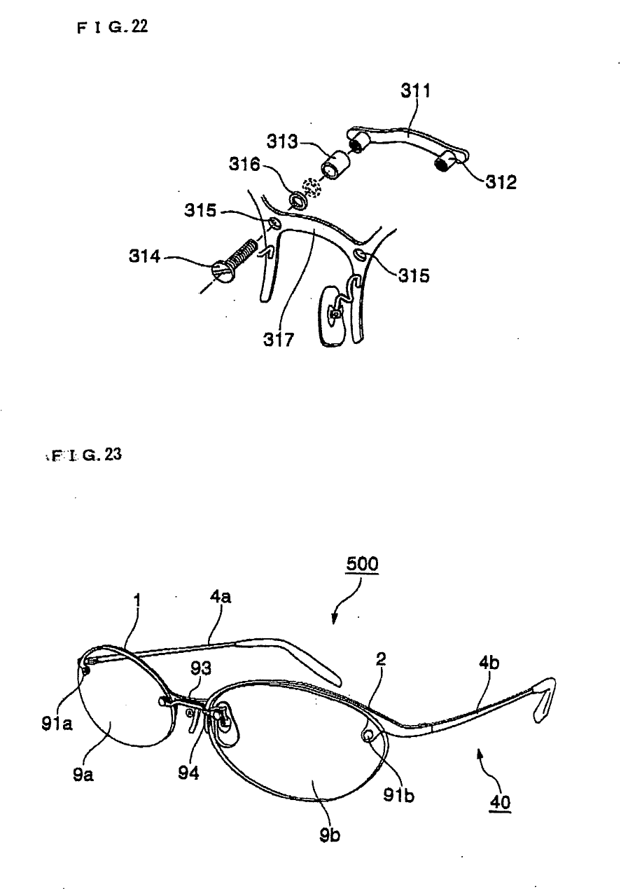

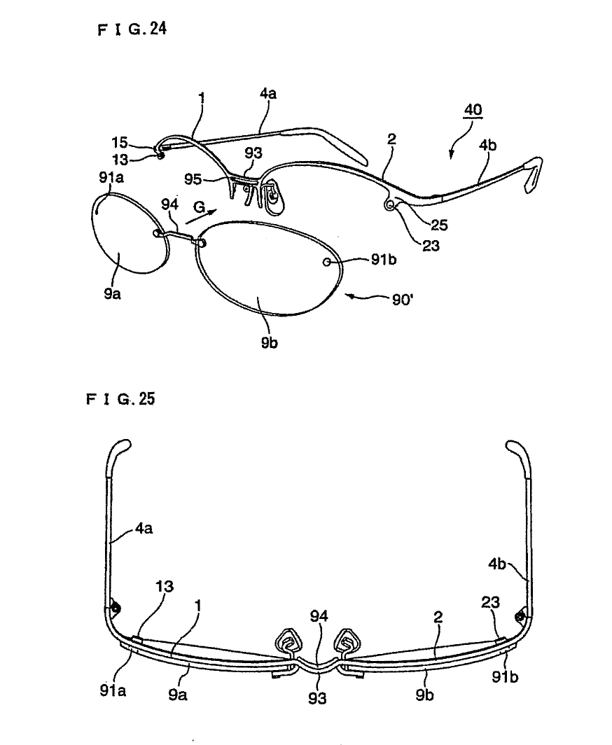

FIG. 23 is an overall perspective view of the spectacles pertaining to Embodiment 9, FIG. 24 is a perspective view illustrating the state when the lens unit is mounted in the frame, and FIG. 25 is a plan view of FIG. 23. In Embodiment 9, those members that are the same as in Embodiment 2 are numbered the same, and will not be described in detail again.

As shown in FIGS. 23 through 25, the spectacles 500 pertaining to Embodiment 9 differ from those in Embodiment 2 in the structure of a bridge 93 and the structure of a linking part 94 in the lens unit 90′.

In the frame 40, the bridge 93 has a hole 95. In the lens unit 90′, the linking part 94 is substantially a box section in shape, open at the front (when viewed from the front), and this substantially open-box shape complements the hole 95.

The lens unit 90′ is moved in the direction of arrow G, and the linking part 94 is engaged in the hole 95. At this time, the magnet 13 provided on the right rim 1, and the magnet 91a provided on the lens unit 90′ exert a pull on each here other by magnetic force, and the magnet 23 provided to the left rim 2, and the magnet 91b provided to the lens unit 90′ also exert a pull on each other by magnetic force. This allows the lens unit 90′ to be attached to the frame 40 with ease, without having to use a tool or the like.

Again in Embodiment 9, as in Embodiment 2, the lens unit 90′ is effectively prevented from coming out of the frame 40. Also, again in Embodiment 9, as in Embodiment 2, a plurality of lens units can be readied and appropriately exchanged as needed.

Tenth Embodiment

FIG. 27 is a detail enlargement illustrating the attraction holding state produced by magnets in the spectacles pertaining to Embodiment 10. The spectacles pertaining to Embodiment 10 differ from those in Embodiment 1 in that the frame does not have the flanges 15 and 25, and a magnet case 154 containing the magnet 13 is fixed to the frame via an arm 153. In Embodiment 10, those members that are the same as in Embodiment 1 are numbered the same, and will not be described in detail again.

As shown in FIG. 27, the magnet case 154 is in a cylindrical shape that is open at the front, and holds the cylindrical magnet 13 in its interior. The arm 153 is fixed to the rear of the magnet case 154 (when viewed from the front), and the magnet case 154 is fixed to the right rim 1 via the arm 153. The arm 153 extends from the right rim 1 in an approximate U-shape, and supports the magnet case 154 from the rear. The same applies to the magnet 23 of the left rim 2.

In Embodiment 10, the arm 153 is provided to absorb force in the forward and backward direction (viewed from the front), so the positions of the magnets 13 and 23 on the frame side can be adjusted longitudinally (viewed from the front), thus allowing the magnets 13 and 23 to come into proper contact with the magnets 81a and 81b on the lens side, and more effectively prevents the lenses 8a and 8b from falling out of the frame.

Eleventh Embodiment

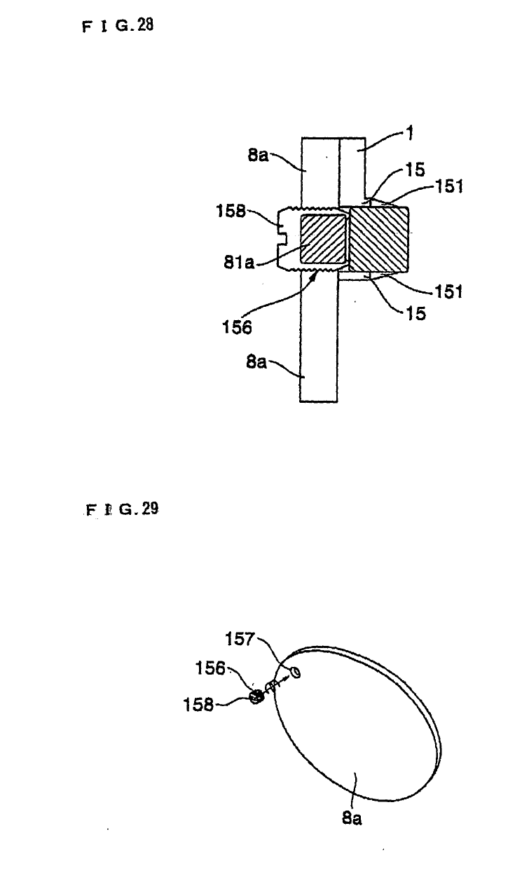

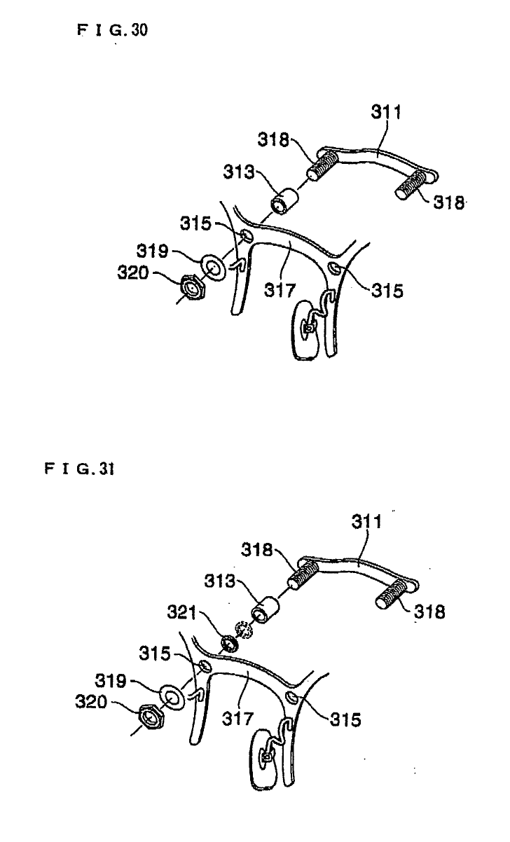

FIG. 28 is a detail enlargement illustrating the attraction holding state produced by magnets in the spectacles pertaining to Embodiment 11, and FIG. 29 is a diagram of the state when a magnet case is inserted into a lens. The spectacles pertaining to Embodiment 11 differ from those in Embodiment 1 in that the magnet 81a is housed in the magnet case 158, and this magnet case 158 is fitted into a hole in the lens. In Embodiment 11, those members that are the same as in Embodiment 1 are numbered the same, and will not be described in detail again.

As shown in FIGS. 28 and 29, the lens 8a has a hole 157 in which the magnet case 158 is fitted. The magnet case 158 is cylindrical and open at the rear (when viewed from the front), and holds the cylindrical magnet 81a inside. Threaded grooves 156 are cut around the outer peripheral surface of the magnet case 158. As shown in FIG. 29, the magnet case 158 is attached to the lens 8a by being fitted into the hole 157. The same applies to the magnet 81b of the left rim 2.

In Embodiment 11, the magnets 81a and 81b on the lens side are housed in the magnet case 158, and this magnet case 158 itself has a threaded construction so that the magnets 81a and 81b can be easily attached to the lenses 8a and 8b merely by making holes 157 in the lenses 8a and 8b for fitting the magnet cases 158, and then fitting these magnet cases 158 into these holes 157.

In Embodiments 1 through 11, a case of utilizing magnetic force produced between the magnet 13 and the magnet 81a and between the magnet 23 and the magnet 81b was described, but it is also possible for only the magnets 13 and 23 on the frame side, or the magnets 81a and 81b on the lens side to be magnets, for the other two to be components made from a metal that is attracted to a magnet.

Also, if the magnets or magnet cases are suitably colored, they can further enhance the aesthetic design of the spectacles by providing a detail highlight.

Finally, the above description was for so-called sunglasses, in which lenses with no diopter were used, but lenses with a diopter may be used instead.

Twelfth Embodiment

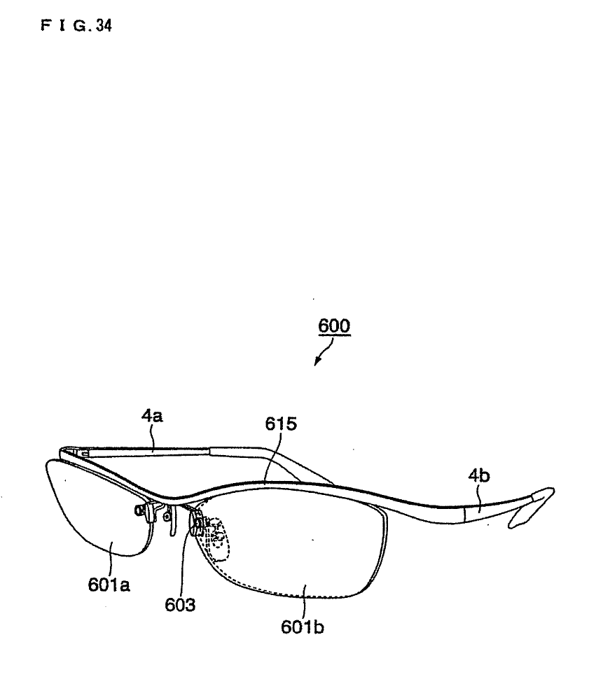

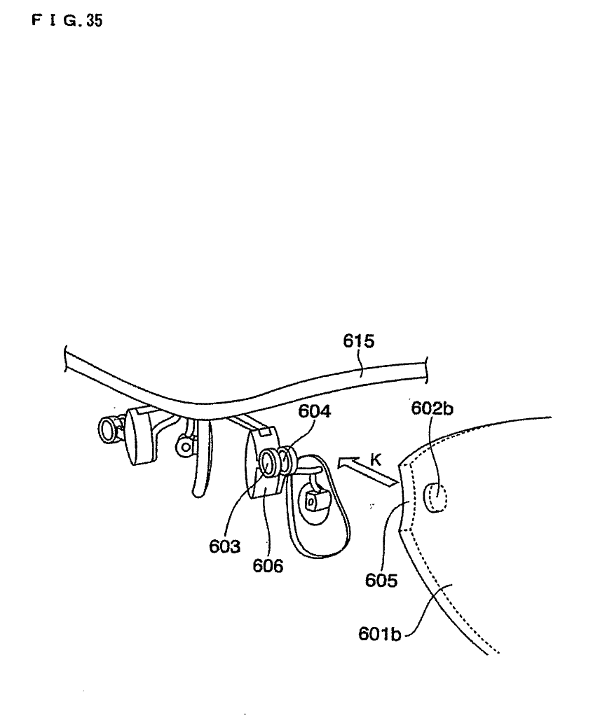

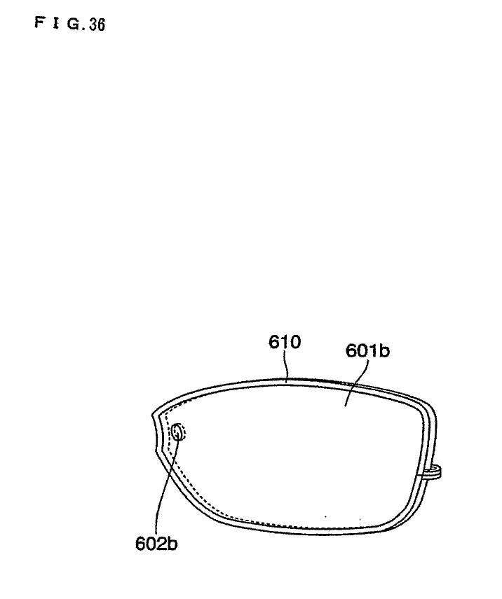

FIG. 34 is an overall oblique view of the spectacles pertaining to the twelfth embodiment, and FIG. 35 is a diagram illustrating how the lenses are mounted in the frame.

As shown in FIG. 34, a pair of spectacles 600 comprises a frame 615 and lenses 601a and 601b. The frame comprises a rim 615 and temples 4a and 4b. Just as in the above embodiment, the rim 615 is shaped such that there is a notch in the lower portion of a ring-shaped surround, and has a shape that complements the shape of the upper end of the lenses 601a and 601b.

As shown in FIGS. 34 and 35, the lens 601b has a crescent-shaped recess 605 at the end near the center when viewed from the front, and a small, cylindrical magnet 602b is embedded in the vicinity of this recess. The rim 615 comprises a member having a pair of magnets 603 and 604 and a protrusion 606 shaped complementarily with the recess 605.

The lens 601b is moved in the direction of arrow K, and the recess 605 of the lens 602b is engaged with the protrusion 606. Here, the pair of magnets 603 and 604 and a magnet 602b exert a pull on each here other by magnetic force, so the lens 602b can be attached to the rim 615 with ease. The lens 601a can be attached with similar ease to the rim 615.

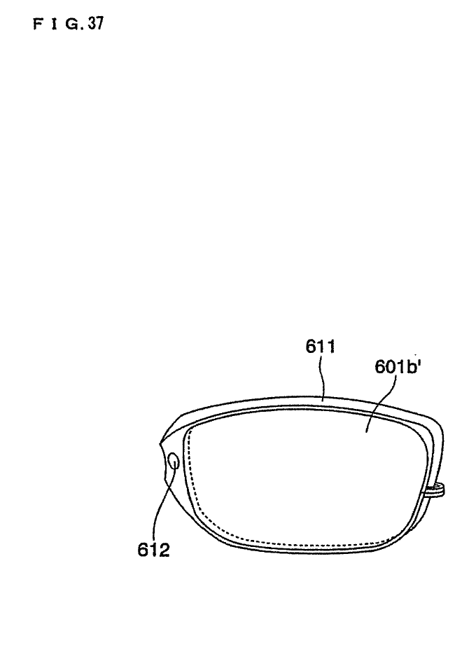

The lens 601b may be rimless, or it may be equipped with a rim as shown in FIG. 36. Also, the lens 601b′ may be equipped with a rim 611 and a magnet 612 attached to this rim 611, as shown in FIG. 37.

Thirteenth Embodiment

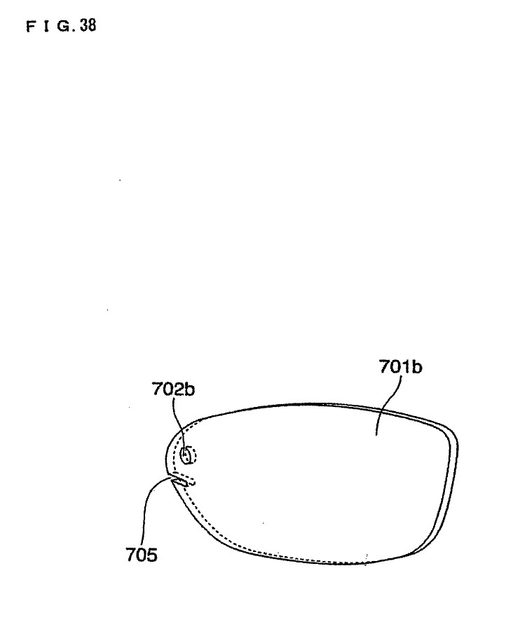

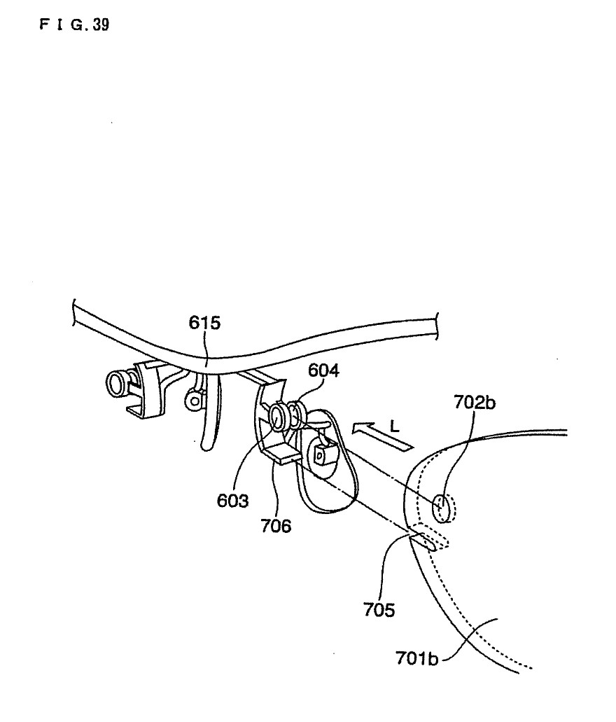

FIG. 38 illustrates the lenses pertaining to Embodiment 13, while FIG. 39 is a diagram illustrating how the lenses are mounted in the frame in Embodiment 13.

As shown in FIGS. 38 and 39, this embodiment differs from Embodiment 12 in that a lens 701b has a notch-shaped recess 705, and the rim 615 is equipped with a protrusion 706 shaped complementarily with the recess 705.

The lens 701b is moved in the direction of arrow L, and the recess 705 of the lens 701b is engaged with the protrusion 706. Here, the pair of magnets 603 and 604 and a magnet 702′) exert a pull on each here other by magnetic force, so the the lens 702b can be attached to the rim 615 with ease. The left lens can be attached with similar ease to the rim 615.

### INDUSTRIAL APPLICABILITY

With the spectacles and spectacle set of the present invention, the lenses can be easily put in and taken out of the frame, and held securely therein, without damaging the aesthetic design of the spectacles.

1. Spectacles comprising a frame and lenses that are mounted in this frame, wherein
the frame comprises an engagement holding mechanism near its middle when viewed from the front, for holding said lenses by engaging a mating component provided to said lenses; and an attraction holding mechanism near the two ends when viewed from the front, for holding the lenses by magnetic force.

2. The spectacles according to claim 1, wherein the frame has a right rim, a left rim, a bridge that links the right and left rims, and temples linked to the right and left rims,
said lenses consist of a right lens and a left lens, and
said engagement holding mechanism comprises a first engagement holding mechanism that is provided to said right rim and engages and holds the end part of said right lens, and a second engagement holding mechanism that is provided to said left rim and engages and holds the end part of said left lens.

3. The spectacles according to claim 2, wherein said first and second engagement holding mechanisms each consist of at least one protruding part that is substantially U-shaped and whose open end extends facing the approximate center of the lens, and the end parts of the right and left lenses are engaged and held in recessed parts demarcated by the insides of these substantially U-shaped curved portions.

4. The spectacles according to claim 3, wherein said protruding parts are covered on at least the inside of said recessed parts with a silicone-based resin.

5. The spectacles according to claim 4, wherein said first and second engagement holding mechanisms each comprise two protruding parts, and
the insides of said recessed parts covered with said silicone-based resin both form an arc with substantially the same radius of curvature.

6. The spectacles according to claim 1, wherein said frame has a right rim, a left rim, a bridge that links the right and left rims, and temples linked to the right and left rims,
said lenses consist of a right lens having a recessed part at its end part and a left lens having a recessed part at its end part, and
said engagement holding mechanisms comprise said bridge, one part of this bridge being engaged with the inside of the recessed part in said right lens and one part with the inside of the recessed part in said left lens.

7. The spectacles according to claim 6, wherein said bridge comprises a first member that lies on substantially the same plane as the right and left rims and links the right and left rims, two post-shaped parts extending in post shape toward the front surface, and a second member that links the front end parts of these two post-shaped parts,
and said engagement holding mechanism is such that said two post-shaped parts are engaged and held in the recessed part of said right lens and in the recessed part of said left lens respectively.

8. The spectacles according to claim 7, wherein said post-shaped parts are in the form of cylinders that are threaded on the inner peripheries thereof, and are integrated with said second member at the front surface end,
said frame has two holes, and
said bridge is constituted by inserting screws into the inner periphery parts of said post-shaped parts through said holes from the back side when viewed from the front.

9. The spectacles according to claim 7, wherein said post-shaped parts are in the form of cylinders that are threaded on the outside peripheries thereof, and are integrated with said second member at the front surface end,
said frame has two holes, and
said bridge is constituted by inserting said post-shaped parts into said holes and screwing nuts from the back side when viewed from the front.

10. The spectacles according to claim 9, further comprising springs between said nuts and the frame.

11. The spectacles according to claim 8, wherein said bridge is constituted with washers interposed between said first members and said post-shaped parts.

12. The spectacles according to claim 8, wherein said post-shaped parts are equipped with cylindrical silicone pipes around their outer peripheries.

13. The spectacles according to claim 1, wherein said frame has a right rim, a left rim, a bridge that links the right and left rims, and temples linked to the right and left rims,
said lenses consist of a lens unit in which the right and left lenses are linked via a linking part, and
said engagement holding mechanisms comprise said bridge, said linking part being engaged by this bridge so as to hold said lens unit.

14. The spectacles according to claim 1, wherein the main component of said frame is beta-titanium or stainless steel.

15. The spectacles according to claim 1, wherein said attraction holding mechanism comprises an attracting member provided on the lens, and an attracted member provided to the frame and attracted by the attracting member, and
the end parts of said attracting members protrude rearward from the lenses when viewed from the front.

16. The spectacles according to claim 15, wherein at least part of said attracted member is fitted in a case, and this case is fixed to the frame via a holding member that absorbs force in the forward and rearward directions when viewed from the front.

17. The spectacles according to claim 15, wherein said lenses each have a hole into which said attracting member is fitted, and
said attracting member is housed in a case that is threaded around the outer peripheral surface thereof, and this case is attached to the lens by being fitted into said hole.

18. A spectacles set, having a frame that constitutes the spectacles according to claim 1, and a plurality of right lenses and a plurality of left lenses detachably attached to this frame.

19. A spectacles set, having said frame that constitutes the spectacles according to claim 1, and a plurality of lens units detachably attached to this frame.

20. Spectacles comprising a frame and lenses that are mounted in said frame,
wherein the frame comprises an engagement holding mechanism near its middle when viewed from the front, for holding the lenses by engaging a mating component provided to the lenses; and an attraction holding mechanism near the middle thereof when viewed from the front, for holding the lenses by magnetic force.

21. The spectacles according to claim 20, wherein the lenses consist of a right lens having a recess at the end, and a left lens having a recess at the end, and
the engagement holding mechanism comprises a protrusions that engage in the recesses of the right and left lenses.

22. The spectacles according to claim 20, wherein the attraction holding mechanism comprises an attracting member provided to the lens, and an attracted member provided to the frame and attracted by the attracting member.
